(19) United States
(12) Patent Application Publication
(10) Pub. No.: US 2013/0231057 A1
(43) Pub. Date: Sep. 5, 2013

(54) STATIONARY ANALOG FM-RECEIVER FOR RECEIVING ANALOG WIRELESSLY TRANSMITTED FM-AUDIO SIGNALS FROM AT LEAST ONE MOBILE UNIT AND A METHOD OF RECEIVING AN ANALOG FREQUENCY-MODULATED AUDIO SIGNAL FROM A MOBILE ANALOG FM-TRANSMITTER

(71) Applicant: SENNHEISER ELECTRONICS GMBH & CO. KG, Wedemark (DE)

(72) Inventors: Sebastian GEORGI, Langenhangen (DE); Carsten Bischoff, Wedemark (DE)

(73) Assignee: Sennheiser electronics GmbH & Co. KG, Wedemark (DE)

(21) Appl. No.: 13/752,618

(22) Filed: Jan. 29, 2013

(30) Foreign Application Priority Data
Jan. 31, 2012 (DE) 102012201372.5

(51) Int. Cl. H04B 1/10

(52) U.S. Cl. CPC H04B 1/1027
USPC 455/42

(57) ABSTRACT

There is provided a stationary analog FM-receiver for receiving analog wirelessly transmitted FM-audio signals from at least one mobile unit. The frequency has a frequency demodulator (FDM) for demodulating the received FM-audio signals. The FM-receiver further has a link quality unit (LQE) for determining a link quality for the wireless transmission of the FM-audio signals. The link quality unit (LQE) has a high-pass filter (HP) with a limit frequency for high-pass filtration of an output signal of the frequency demodulator (FDM) and a power determining unit (SE, LBE) for determining the power of the output signal of the high-pass filter (HP). The limit frequency of the high-pass filter (HP) lies in the region of between 20 kHz and 80 kHz, in particular in the region of between 50 kHz and 80 kHz.

The present application claims priority from German Patent Application No. DE 10 2012 201 372.5 filed on Jan. 31, 2012, the disclosure of which is incorporated herein by reference in its entirety.

### 1. FIELD OF THE INVENTION

The present invention concerns a stationary analog FM-receiver for receiving analog wirelessly transmitted FM-audio signals from at least one mobile unit and a method of receiving an analog frequency-modulated audio signal from a mobile analog FM-transmitter.

It is noted that citation or identification of any document in this application is not an admission that such document is available as prior art to the present invention.

The transmission quality (LQI or link quality indicator) of present day FM (frequency modulation) paths for audio transmission is adjudged on the basis of the measured reception power of the input signal, the so-called RSSI value (received signal strength indicator) and the subjective perception by the human ear. Disadvantage with both methods are that the ear only notices the inadequate quality when the interference situation has already occurred, that subjective assessments are difficult to generalize, that automation of the auditory process is extremely difficult and that the RSSI value only indicates that there is power in the channel, but does not distinguish between useful signal and inband interferer. A large RSSI value does not make it possible to specify whether the situation involves a large useful signal, a large interference signal or two useful and interference signals which are approximately of equal magnitude.

On the basis of the transmission quality LQI interference in an analog FM (frequency-modulated) radio channel is intended to be recognized by another transmitter and countermeasures taken. Evaluation of the reception power RSSI however does not make it possible to distinguish between a signal and an interference.

The German Patent and Trade Mark Office searched the following documents in the application from which priority is claimed: U.S. Pat. No. 6,480,722 B1, US No. 2009/0274251 A1 and EP 0 653 850 A2.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

Therefore an object of the present invention is to provide a stationary analog FM-receiver for an analog wireless FM-audio transmission system, which permits the signal-to-interference ratio (SINR) to be more accurately determined.

Thus there is provided a stationary analog FM-receiver for receiving analog wirelessly transmitted FM-audio signals from at least one mobile unit. The receiver has a frequency demodulator for demodulating the received FM-audio signals. In that case the FM-audio signals can represent FM-signals which contain audio signals or audio information. The FM-receiver further has a link quality unit for determining a link quality for the wireless transmission of the FM-audio signals. The link quality unit has a high-pass filter with a limit frequency for high-pass filtering of an output signal of the frequency demodulator and a power determining unit for determining the power of the output signal of the high-pass filter. The limit frequency of the high-pass filter lies in the region of between 20 kHz and 80 kHz and in particular in the region of between 50 kHz and 90 kHz.

In an aspect of the present invention the limit frequency is in the region of between 33 kHz and 80 kHz.

The stationary analog FM-receiver according to the invention serves to permit analog FM-transmission of audio signals.

The invention further concerns a stationary analog FM-receiver for receiving analog wirelessly transmitted FM-audio signals from at least one mobile unit. The receiver has at least two antennae for receiving FM-audio signals, a frequency demodulator for demodulating the received FM-audio signals, and a link quality unit for determining the link quality for the wireless transmission of the FM-audio signals for each of the at least two antennae and for selecting that one of the at least two antennae, which has the best link quality.

The present invention concerns the notion of providing a stationary analog FM-receiver for receiving analog FM-modulated audio signals, which are communicated from at least one mobile unit with an analog-FM transmitter. Those mobile transmitters can represent for example wireless microphones and/or pocket transmitters. The receiver has a frequency demodulator to demodulate the received analog FM-signals. The receiver also has a link quality unit with a high-pass filter HP which performs filtering of the output signal of the frequency demodulator. The limit frequency of the high-pass filter HP can be between 20 kHz and 80 kHz. The power of the output of the high-pass filter is detected in the link quality unit and serves as a measurement of the transmission quality or link quality. The more power that is measured, the correspondingly lower is the SINR. After detection of the power evaluation is effected on the basis of characteristic (for example FIG. 3).

An example of analog FM-transmission of audio signals according to the invention is represented by a wireless microphone system. The wireless microphones or pocket transmitters have a transmitter for the transmission of audio signals based on an analog FM-modulation. The wireless microphones are mobile transmitters and transmit the analog FM-modulated audio signals to a stationary receiver. The range of the mobile units is typically less than 150 m.

According to an aspect of the present invention the limit frequency of the high-pass filter lies in the region of between 20 kHz and 50 kHz so that the power of the signals is detected above the limit frequency.

### BRIEF DESCRIPTION OF THE DRAWINGS

FIG. 1 shows a reception spectrum of a receiver according to the invention;

FIG. 2 shows a schematic block circuit diagram of a receiver according to a first embodiment;

FIG. 3 shows a graph to illustrate the reception power in the case of a receiver according to the invention; and

FIG. 4 shows a graph to illustrate the low-frequency spectrum with interferences in the case of a receiver according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

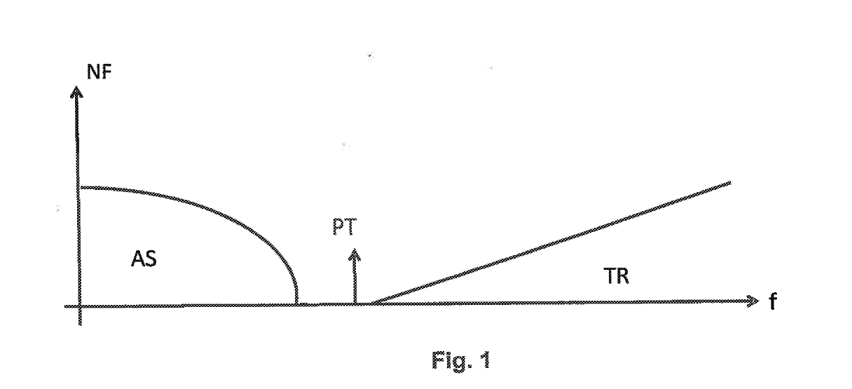

FIG. 1 shows a reception spectrum of a receiver according to the invention. The receiver according to the invention represents a stationary analog FM-receiver for receiving analog wirelessly transmitted FM-audio signals from at least one mobile unit such as for example a wireless microphone or a wireless pocket transmitter. FIG. 1 shows in particular the low frequency LF spectrum on the Y-axis and the frequency f on the X-axis. The LF spectrum thus contains audio signals AS, optionally a pilot tone PT and optionally thermal noise TR and interference components. According to the invention the frequency range above the audio signals AS is analyzed more precisely to determine the transmission or link quality. In particular the power of the signals above the audio signals AS is determined in order to check whether there is an interferer in the transmission channel.

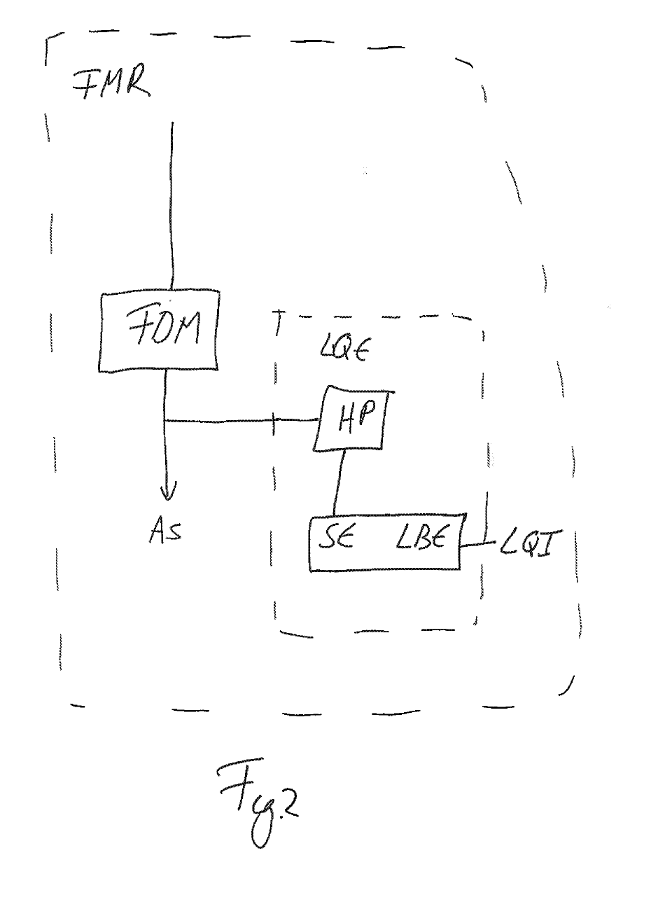

FIG. 2 shows a schematic block circuit diagram of a receiver according to a first embodiment. The receiver of the first embodiment preferably represents a stationary analog FM-receiver FMR for receiving analog wirelessly transmitted FM-audio signals from at least one mobile unit. The receiver FMR has a demodulator FDM for demodulating the frequency-modulated received analog signal. The output of the demodulator FDM is passed to a link quality unit LQE. The output signal of the demodulator FDM also represents the demodulated audio signal.

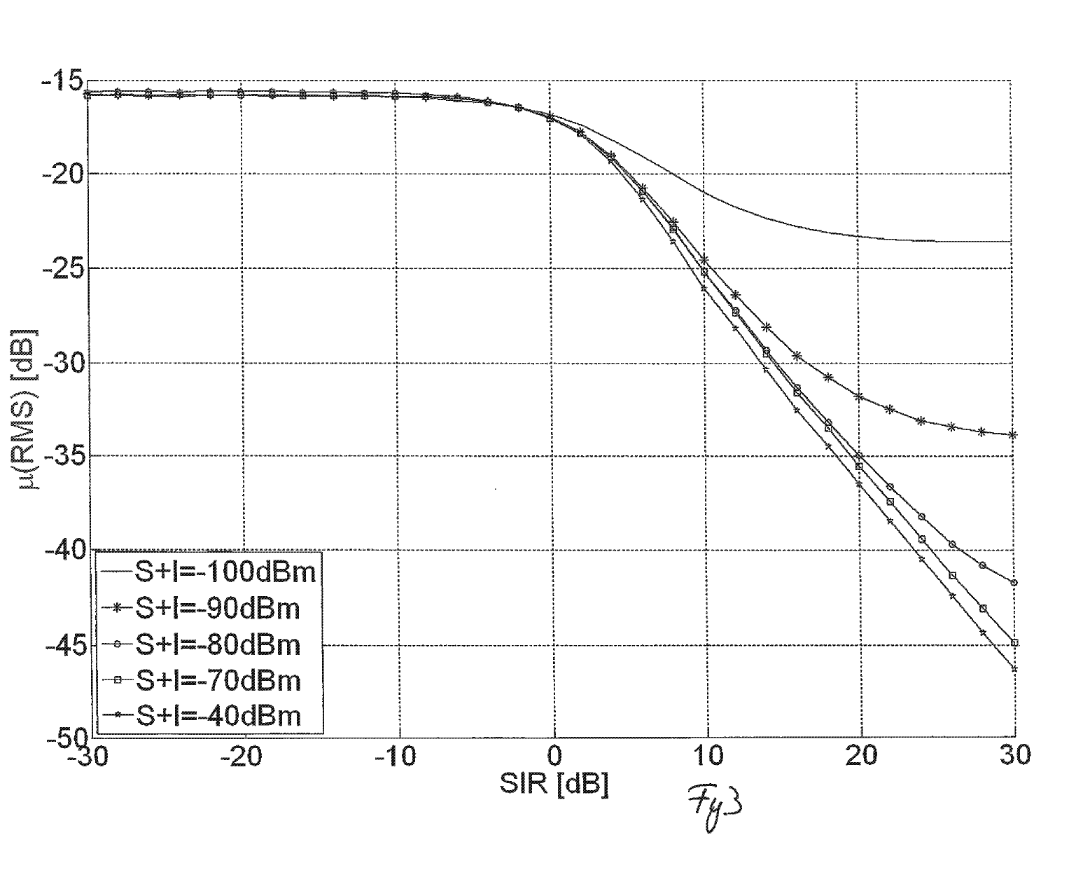

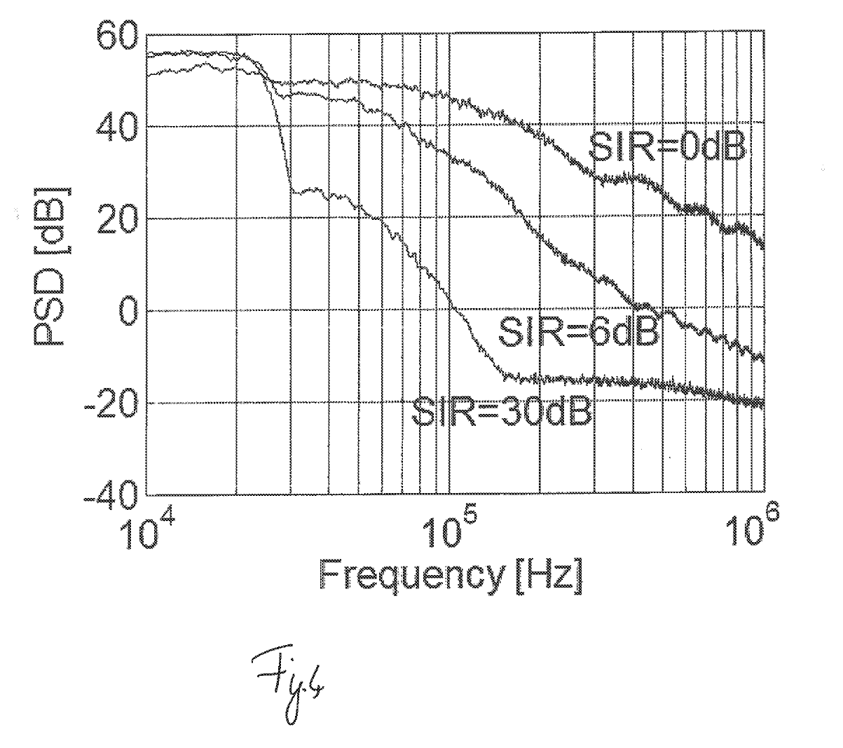

The link qnality unit LQE has a high-pass filter HP and a power determining unit LBE. The high-pass filter HP has a limit frequency above the audio signals, that is to say above 20 kHz, for example in a region of between 20 kHz and 80 kHz, in particular between 20 kHz and 50 kHz or between 50 kHz and 80 kHz. Accordingly only those received and demodulated signals involving a frequency of for example >20 kHz are considered in the link quality unit LQE. In particular the power of those signals is determined in the link quality unit LQE. On the basis of the power of those signals, it is possible by means of the characteristics KEN of FIGS. 3 and 4 and the RSSI to detect whether there is an interferer in the transmission channel and how great the SINR is.

Optionally the RSSI value can be determined based on the input signal IN.

In the link quality unit LQE high-pass filtering is effected by the high-pass filter HP, summing and logarithmisation of the power of the output signals of the high-pass filter HP is implemented in the power determining unit LBE or alternatively or additionally RMS formation of the voltage.

FIG. 3 shows a graph to illustrate the reception power in a receiver according to the invention. In particular FIG. 3 shows a family of characteristics KEN of the measured power of the output signal of the high-pass filter HP for various RSSI values in dependence on the signal-to-interference ratio SINR. In particular FIG. 3 shows five different reception powers RSSI (S+I, transmitter+interference), namely −100 dB, −90, −80, −70 and −40 dBm. The interference is generated by an OFDM wide-band interferer.

If the RSSI value is known then the corresponding characteristic KEN can be selected for evaluation purposes.

FIG. 4 shows a graph to illustrate the low-frequency spectrum in a receiver according to the invention. FIG. 4 also shows the graphs with different SIR ratios (0, 6 and 30 dB). It is thus possible to conclude from FIG. 4 that those components of the LF spectrum which occur due to interference are concentrated at lower frequencies with a rising ratio SIR. Thus the best results can be achieved in respect of link quality with frequencies above the audio signals (20 kHz) and below 100 kHz (10⁵ Hz). That range is particularly advantageous to achieve a high dynamic range in respect of the LQI.

In terms of selection of the limit frequency, the finite quality of the filters and the slope of the filters should be taken into account. To be able to use an inexpensive filter (with a lesser slope and thus lower costs) the limit frequency should be appropriately selected. For example 50 kHz can be selected as a compromise in respect of the limit frequency. With 50 kHz that limit frequency is sufficiently fax away from a possible pilot tone and the filter does not have to be selected to be too steep.

It should also be noted that, as can be seen from FIG. 4, in the region above 100 kHz only slight changes occur, which no longer have a high dynamic range.

Optionally in accordance with an aspect of the present invention the stationary receiver can have a plurality of antennae so that it is possible to use antennae diversity. Optionally the link quality can also be used to control diversity switching. The comparison of the reception power of the two antennae can be used as an indicator for switching over. Here however the same applies as in the case of a receiver with only one antenna. If only the reception power is detected, it is not possible to distinguish between the power of an interferer and the useful signal. In the diversity mode of operation, the situation can occur that an interferer is disposed in the proximity of a first reception antenna and the reception powers without interferer would be approximately equal; then the interferer can increase the reception power at the first antenna. In such a situation however switching over to the second antenna could be desirable although RSSI-based diversity switching would decide for the first antenna.

According to the invention a plurality of antenna can be connected to the receiver or the receiver can have a plurality of antennae so that it is possible to provide an antenna diversity receiver. In that case the link quality can be ascertained individually for each of the antennae, as described hereinbefore. A choice of the antenna signal to be used can then be made based on a comparison of the respectively ascertained link quality (each of the antennae). In other words the link quality is individually ascertained for each of the antennae and it is then possible to determine which of the link qualities has the best value. The correspondingly associated antenna or the antenna signal can then be selected as the antenna or antenna signal.

In an aspect of the present invention the detected link quality indicator LQI is used for switching over in the case of an antenna diversity, instead of considering only the reception power.

In a further aspect of the invention the analog audio signal can be subjected to low-pass filtering in the transmission of an audio signal, and then a pilot tone (for example involving a constant frequency of 32.768 kHz) can be superimposed. The result is then the LF signal to be transmitted. The LF signal is transformed with a frequency modulator in the carrier frequency range and transmitted as an HF (high frequency) signal. The amplitude of the LF signal corresponds to the frequency of the HF signal. Frequency modulation represents a non-linear operation, that is to say a sum of two frequency-modulated signals does not correspond to frequency modulation of the two sums.

According to the invention the FM-signal transmitted in analog form is demodulated by the frequency demodulator FDM. An LF spectrum by way of example is shown in FIG. 1. Above the pilot tone PT there are only still signal components which occur by virtue of thermal noise. With the same RSSI the energy of the LF spectrum above the pilot tone remains the same. According to the invention the limit frequency of the high-pass filter HP is above the audio useful band. As an alternative thereto the limit frequency of the high-pass filter HP can be provided above the existing pilot tone PT. As a compromise in respect of filter order, flank slope and attenuation, it is possible to provide a limit frequency of 50 kHz with a pilot tone of 32.768 kHz. It should be pointed out that however other limit frequencies are also possible.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A stationary analog FM-receiver for receiving analog wirelessly transmitted FM-audio signals from at least one mobile unit, comprising;
a frequency demodulator configured to demodulate the received FM-audio signals; and
a link quality unit configured to determine a link quality for the wireless transmission of the FM-audio signals;
wherein the link quality unit has
a high-pass filter with a limit frequency for high-pass filtration of an output signal of the frequency demodulator; and
a power determining unit configured to determine the power of the output signal of the high-pass filter; and
wherein the limit frequency of the high-pass filter lies in a region of between 20 kHz and 80 kHz.

2. The receiver as set forth in claim 1;
wherein the limit frequency lies in a region of between 33 kHz and 80 kHz.

3. The receiver as set forth in claim 1, further comprising:
a power determining unit for determining the power of an input signal;
wherein the link quality unit configured, on the basis of the power of the input signal, to select, from a plurality of previously measured families of characteristics of the power of the output signals of the high-pass filter, a family of characteristics of an output signal of the high-pass filter.

4. A stationary analog FM-receiver for receiving analog wirelessly transmitted FM-audio signals from at least one mobile unit, comprising:
at least two antennae for configured to receive FM-audio signals;
a frequency demodulator configured to demodulate the received FM-audio signals; and
a link quality unit configured to determine a link quality for the wireless transmission of the FM-audio signals for each of the at least two antennae, and configured to select one of the at least two antennae which has a better link quality than the other of the at least two antennae.

5. The receiver as set forth in claim 4;
wherein the link quality unit has:
a high-pass filter with a limit frequency for high-pass filtration of an output signal of the frequency demodulator; and
a power determining unit configured to determine the power of the output signal of the high-pass filter;
wherein a limit frequency of the high-pass filter lies in a region of between 20 kHz and 80 kHz.

6. A method of receiving an analog frequency-modulated audio signal from a mobile analog FM-transmitter, comprising:
performing frequency demodulation of the received audio signal;
high-pass filtering the frequency-modulated signal with a limit frequency; and
ascertaining the power of the high-pass filtered signal;
wherein a limit frequency lies in a region of between 20 kHz and 80 kHz.

7. The receiver as set forth in claim 1;
wherein the limit frequency lies in a region of between 50 kHz and 80 kHz.

8. The receiver as set forth in claim 4;
wherein the limit frequency lies in a region of between 50 kHz and 80 kHz.

9. The method as set forth in claim 6;
wherein the limit frequency lies in a region of between 50 kHz and 80 kHz.
